(19) United States
(12) Patent Application Publication
(10) Pub. No.: US 2006/0136226 A1
(43) Pub. Date: Jun. 22, 2006

(54) System and method for creating artificial TV news programs

(76) Inventor: Ossama Emam, Giza (EG)

Correspondence Address: IBM CORPORATION;INTELLECTUAL PROPERTY LAW, 11400 BURNET ROAD, AUSTIN, TX, 78758, US

(21) Appl. No.: 11/236,457

(22) Filed: Sep. 27, 2005

(30) Foreign Application Priority Data
Oct. 6, 2004 (EP) 04300659.2

(51) Int. Cl. G10L 11/00

(52) U.S. Cl. 704/277

(57) ABSTRACT

The present invention relates to interactive television, in particular to a method and system for creating artificial TV programs according to TV viewers' preferences and more particularly to a system and method for enabling a TV viewer to replace the newscaster of a TV news program by an artificial newscaster and to translate the newscaster's speech into the language of his choice. The present invention combines automatic speech recognition (Speech-To-Text processing), automatic machine translation, and audio-visual Text-To-Speech (TTS) synthesis techniques for automatically personalizing TV news programs.

### TECHNICAL FIELD OF THE INVENTION

The present invention relates to interactive television, in particular to a method and system for creating artificial programs and more particularly to a system an method for enabling a television viewer to select the language and the anchorperson of his choice in a television program, in particular in a news program.

### BACKGROUND ART

### Technical Field

The present invention combines automatic speech recognition (Speech-To-Text processing), automatic machine translation, and audio-visual Text-To-Speech (TTS) synthesis techniques for automatically personalizing TV news programs.

Nowadays, it is practically impossible to broadcast a same news program in several languages at the same time. This requires a lot of resources such as a studio, one or several anchormen/women and broadcasting means. However, with the wide spread and ever increasing use of broadcast, cable and satellite television, the need to broadcast a program, especially a news program, in several languages is becoming more and more vital. People have a real need to watch news in the language of their choice (in the mother tongue for instance) even if these programs are broadcast in another language (in a foreign language for instance). In addition, people must have the possibility to change the person who reads the news with another one among a predefined list.

### Personalization of TV Programs

The automatic personalization of TV programs relates to the field of interactive television. To build a program with a predefined duration and a maximum content value for a specific user, the basic principle is to combine video indexing techniques to parse TV news recordings into stories, with information filtering techniques to select the most adequate stories for a given a user profile. The selection process is usually formalized as an optimization problem. The duration is taken into account to select the stories. However, the language and the anchormen of the news programs remain unchanged.

Many world-wide publications describe the various aspects of automatic speech recognition, automatic machine translation, and audio-visual text-to-speech.

U.S. patent application 2001/0025241 entitled “Method and system for providing automated captioning for AV signals”, Lange et al., discloses a system that uses speech-to-text (speech recognition) technology to transcribe the audio signal. The method includes the steps of separating an audio signal from an Audio-Video (AV) signal, converting the audio signal to text data, encoding the original AV signal with the converted text data to produce a captioned AV signal and recording and displaying the captioned AV signal. In a particular embodiment, the spoken words are translated in a first language into words in a second language and are included in the captioning information. The object of the disclosed system is to include the spoken words or their translation in the captioning information using Speech-To-Text and translation technologies.

The present invention goes beyond the system disclosed here above by using the spoken script (or its translation) as an input for an Audio-Visual Text-To-Speech (TTS).

U.S. patent application 2003/0065503 entitled “Multi-lingual transcription system”, Agnihotri et al., discloses a system for filtering text data from the auxiliary information component, translating the text data into the target language and displaying the translated text data while simultaneously playing an audio and video component of the synchronized signal. The auxiliary information component can be any language text associated with an audio/video signal, i.e., video text, text generated by speech recognition software, program transcripts, electronic program guide information, closed caption text, etc. Optionally, the audio component of the originally received signal can be muted and the translated text processed by a Text-To-Speech (TTS) synthesizer to synthesize a voice representing the translated text data. The main object of this system is to provide auxiliary information component (translated text) while simultaneously playing the original audio and video component of the synchronized signal. In the case where Text-To-Speech (TTS) is used, the synthesized speech is played from the set-top box while the original audio is muted.

The present invention goes beyond the system disclosed here above by using the spoken script (or its translation) as an input for an Audio-Visual Text-To-Speech (TTS). New audio and video signals are generated and integrated with the original audio and video signals.

### Speech Recognition

Speech recognition systems or speech-to-text processing systems convert spoken words within an audio signal into text data.

A “Language Model” (LM) is a conceptual device which, given a string of past words, estimates the probability that any given word from an allowed vocabulary follows the string i.e., P(Wₖ, Wₖ₋₁, . . . W₁). In speech recognition, a Language Model (LM) is used to direct the hypothesis search for the sentence that is pronounced. For storage reasons, strings from which the prediction is based on, are partitioned into a manageable number of n words. For instance in a “3-gram” Language Model, the counts are based on tri-grams (sequence of 3 words) and, therefore, the prediction of a word depends on the past two words.

The training “corpus” is the text coming from various sources that is used to calculate the statistics on which the Language Model (LM) is based.

### Speech Synthesis

Speech synthesis systems convert text to audible speech. Speech synthesizers use a plurality of stored speech segments with their associated representation (i.e., vocabulary). To generate speech, the stored speech segments are concatenated. However, because no information is provided with the text to indicate how the speech must be generated, the result is usually an unnatural or robot sounding speech.

Some speech synthesis systems use prosodic information, such as pitch, duration, rhythm, intonation, stress, etc., to modify or shape the generated speech to sound more natural. In fact, voice characteristic information, such as the above prosodic information, can be used to synthesize the voice of a specific person. Thus, the voice of a person can be recreated to “read” a text that the person has not actually read.

U.S. patent application 2004/0107106 entitled “Apparatus and methods for generating visual representations of speech verbalized by any of a population of personas”, Margaliot et al., discloses a system for accepting a speech input and generating a visual representation of a selected persona producing that speech input, based on a viseme (a viseme is a visual representation of a persona uttering a particular phoneme) profile previously generated for the selected persona. The system typically includes a multi-persona viseme reservoir storing, for each of a population of personas, a viseme profile including for each viseme, a visual image or short sequence of visual images representing the persona executing that viseme (e.g. verbalizing a phoneme corresponding to that viseme). To collect a visems profile, the speech specimen is partitioned into phonemes by means of a conventional speech recognition engine. During run-time, an input speech is received, typically from a first communicant who communicates with a partner or second communicant. The phoneme sequence and timing in the input speech are derived by means of a conventional speech recognition engine and corresponding visemes are displayed to the second communicant, each viseme for an appropriate duration corresponding to the timing of the phonemes in the input speech, such that the viseme flow corresponds temporally to the oral flow of speech.

The above described system is related to the Visual part of the Audio-Visual Text-To-Speech (TTS) system used in the present invention.

### OBJECTS OF THE INVENTION

An object of the present invention is to provide a method and system for personalizing a TV program (in particular a news program).

Another object of the present invention is to enable a TV viewer to replace the newscaster of a TV news program by an artificial newscaster and to translate the newscaster's speech in the language of his choice by means of automatic speech recognition, and Text-to-Speech (TTS) techniques.

A further object of the present invention is to enable a TV viewer to watch the news in the language and with the newscaster of his/her choice.

### SUMMARY OF THE INVENTION

The present invention is directed to a method, system and computer program as defined in independent claims.

Further embodiments of the invention are provided in the appended dependent claims.

More particularly, the method according to the present invention for personalizing a television program consists in translating from a first language into a second language a speech of a person in a television program and for replacing in said television program said first person by a second person. The method comprises the steps of:
receiving an audio/video signal corresponding to a television program;
separating said audio/video signal in:
   an audio signal;
   a video signal;
identifying in the audio signal
   audio sequences corresponding to the speech of the first person;
   other audio signals;
generating from the audio signal text corresponding to the speech of the first person;
generating time stamps corresponding to the identified audio sequences;
translating into the second language, the text corresponding to the speech of the first person;
generating from the translated text:
   a synthesized audio signal corresponding to the speech translated into the second language;
   a synthesized video signal showing the second person;
identifying from the video signal and the time stamps corresponding to the identified audio sequences:
   video sequences showing the first person;
   other video sequences;
generating a final video signal by replacing in the video signal, the video sequences showing the first person by the synthetized video signal showing the second person;
generating a final audio signal by replacing in the audio signal, the audio sequences corresponding to the speech recited by the first person in the first language by the synthetized audio signal corresponding to the speech translated into the second language;
generating a final audio/video signal by combining the final audio signal and the final video signal.

In a preferred embodiment, the television program is a news program and the first and second persons are newscasters.

The foregoing, together with other objects, features, and advantages of this invention can be better appreciated with reference to the following specification, claims and drawings.

### BRIEF DESCRIPTION OF THE DRAWINGS

The novel and inventive features believed characteristics of the invention are set forth in the appended claims. The invention itself, however, as well as a preferred mode of use, further objects and advantages thereof, will best be understood by reference to the following detailed description of an illustrative detailed embodiment when read in conjunction with the accompanying drawings, wherein:

FIG. 1 is a general view of the system according to the present invention.

FIG. 2 is a view of the various components and information sources of the system according to the present invention.

FIGS. 3 and 4 show two different possible embodiments according to the present invention.

### PREFERRED EMBODIMENT OF THE INVENTION

The following description is presented to enable one or ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

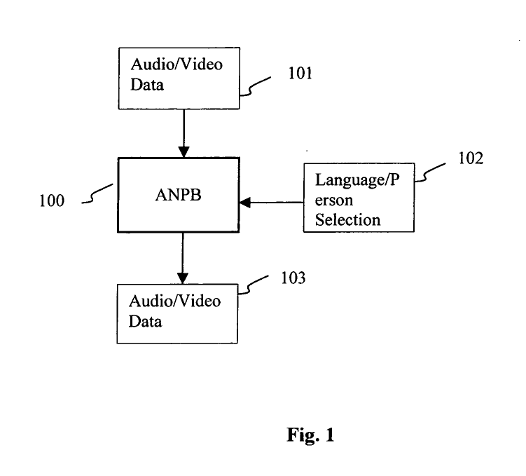

FIG. 1 is a general view of the system according to the present invention. The system called “Artificial News Programs Broadcasted” (ANPB) (100) receives:
broadcast news in the form of audio and video data (101), and
input from the viewer to select a language and a person to read the news (102).

The system outputs the synthesized news program in the form of audio and video data (103).

Note: in the following description the terms “anchorperson/man/woman”, “newsreader”, “newscaster” will be used indifferently.

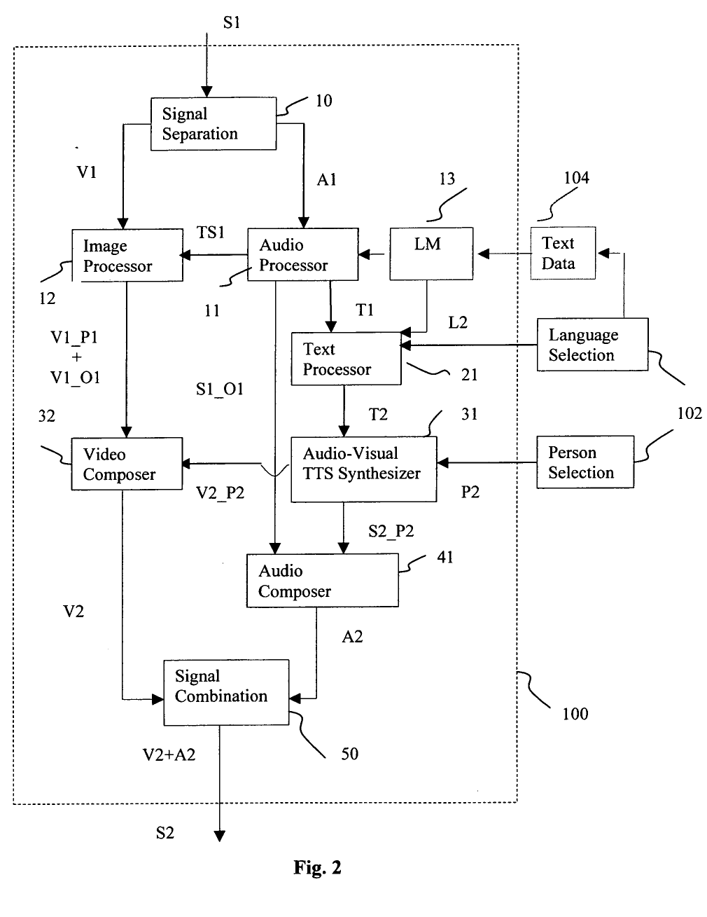

FIG. 2 illustrates the various components and information sources used in the present invention. In this Figure, a dotted line (100) encloses the various components comprised in the system (ANPB) according to the present invention. The ANPB system (100) includes:
a signal separation system (10),
an audio processor (11),
an image processor (12),
a text processor (21),
an audio-visual (talking head) TTS synthesizer (31),
a video composer (32),
an audio composer (41), and
a signal combination system (50).

The way the system operates will be described using the following example: a TV viewer wishes to watch the regular “English” (L1) 9 O'clock news originally read by an “English speaking” (P1) newscaster, in “French” (L2) by “a French speaking newscaster” (P2). The method for broadcasting artificial news programs comprises the following steps:
The TV viewer (102) selects the target language (L2) and the target newscaster (P2) of his choice.
The broadcast audio/video signal (S1) is sent to a signal separation system (10) for separating the signal into
   an audio component (A1), and
   a video component (V1).
The broadcast audio data (A1) is transferred to an Audio Processor (11) to be transcribed and the corresponding text (T1) is generated. The Audio Processor (11) is typically a conventional, commercially available Broadcast News Transcription (BNT) system. In general, Broadcast News Transcription (BNT) systems are designed to:
   automatically create a transcript;
   separate and identify speakers; and
   segment continuous audio input into sections based on speaker, topic, or any changing criteria.

According to the present invention, the Audio Processor (11) outputs:
the text (T1) corresponding to the newscaster (P1),
time stamps (TS1) corresponding to the timing of
   the audio sequences where the newscaster is speaking (S1_P1), and
   the other audio sequences (S1_O1) (music, silences, . . . etc).
The transcribed English text (T1) corresponding to the news that is being read by the English newscaster is used as input for the Text Processor (21) whereas the time stamps (TS1) corresponding to the segments is used as input for the Image Processor (12).
The Text Processor (21) translates the English text (T1) into French (T2). The Text Processor is typically a conventional, commercially available Automatic Machine Translation (AMT) system.
Usually, the Broadcast News Transcription (BNT) (11) and Automatic Machine Translation (AMT) (21) systems consult a Language Model (LM) to predict the words that will likely occur at each point in a sentence of a given language. The BNT uses sophisticated language models to figure out how to combine the sounds into meaningful words. The AMT uses Language Models to figure out how to construct a meaningful sentence. Optionally, the performance of both the BNT and the AMT can be enhanced by using a continuously updated Language Model (LM) (13). In other words, the Language Model (LM) that is used can be improved continuously using a training corpus (see definition above) (104) based on:
   news web sites; and/or
   the script given to the newscaster.
The translated text (T2) is used as input for an Audio-Visual TTS Synthesizer (31) (The Audio-Visual TTS Synthesizer is usually called “visual TTS”). The outputs of the Audio-Visual TTS (31) are the following:
   1. a synthesized audio signal (S2_P2) corresponding to the original speech translated into French.
   2. a synthesized video signal (V2_P2) where the new newscaster is shown.
The Image Processor (12) is a video content description system providing the ability to extract high-level features in terms of human activities rather than low-level features like color, texture and shape. In general, the system relies on an omni-face detection system capable of locating human faces over a broad range of views in videos with complex scenes. The system is able to detect faces irrespective of their poses, including frontal-view and side-view. Using the time stamps (TS1) outputted from the Audio Processor (11), the Image Processor (12) can identify the segments of the video where the original newscaster is shown. The output of the Image Processor sent to the Video Composer (32) comprises:
   the video segments (V1_P1) where the original newscaster is shown, and
   other video segments (V1_O1).
The Video Composer (32):
   receives the corresponding new newscaster video segments (V2_P2) from the visual TTS, in addition to the original newscaster segment information and non-anchorperson video segments (V1_O1), and
   combines the new segments (V2-P2) with the video scenes (V1_O1) that are common and must be kept in the news program scenario (e.g., reporters, recorded shots, . . . etc).
   The output of the Video Composer is the modified final video signal (V2).
   The V1_O1 video signal can be modified to V2_O2 when, for example, a translation of the captions is needed or when any other modification to the original video signal (V1_O1) is introduced.
The Audio Composer (41):
   receives the audio signal (S2_P2) corresponding to the target newscaster, and
   combines the new segments with other audio signals (S1_O1).
   The output of the Audio Composer is the modified final audio signal (A2).
   The S1_O1 audio signal can be modified to S2_O2 when, for example, another music is used at the beginning and at end of the show or when any other modification to the original audio signal (S1_O1) is introduced.

The AudioNideo Data (101) comes from the original broadcaster, while the Language/Person Selection (102) comes from the user side. The new synthesized AudioNideo Data (103) is either at the broadcaster side or at the user side.

### Possible Implementation

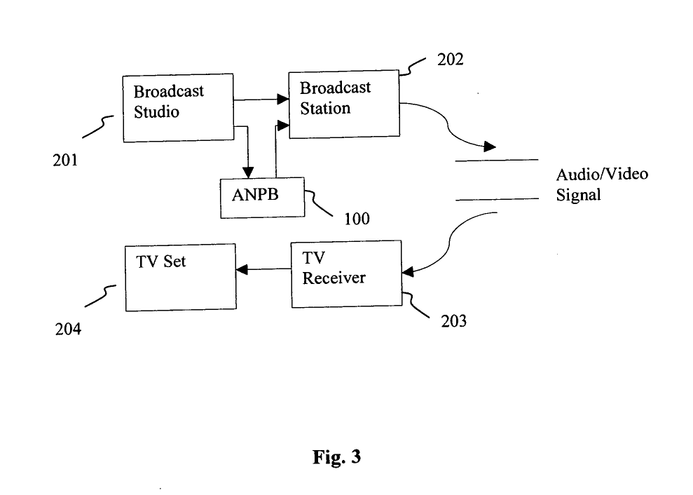

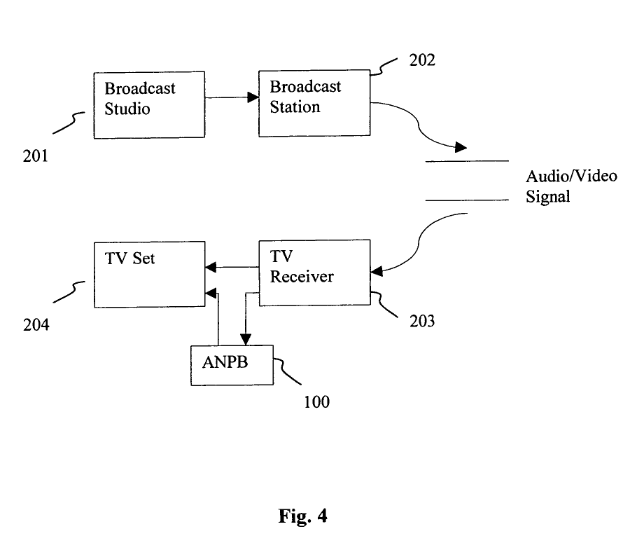

The system according to the present invention (ANPB, 100) can be implemented according to two different scenarios:
1. The first scenario is shown in FIG. 3. At the broadcaster side, news programs that have already been broadcast, are synthesized with different language/person selections. These news programs based on particular language/person selections can then be broadcast on demand and received by the requester (viewer). The output from the broadcast studio (201) is transferred to the ANPB system (100) before being sent to the broadcast station (202). The synthesized program in output of the ANPB system (100), is then sent to the broadcast station before being received (203) and displayed on the TV set (204).
2. The second scenario is shown in FIG. 4. At the user side (receiver side), the news programs are synthesized based on the language/person selected by the user. The broadcast studio (201) sends the news program to the broadcast station (202) where the news program is broadcast to the receiver (203). The program is transmitted from the receiver to the ANPB system (100). The synthesized program in output of the ANPB system is finally sent to the TV set (204).

The selection of the language and choice of the person (102) by the user can be performed by means of keyboards, keypads, TV (set-top box) remote control, or any pointing device to navigate through predefined menus. However, other technologies can be employed to enhance the user interface. For example, an Automatic Speech Recognition (ASR) system can converts spoken words into text stream or some other code, based on the sound of the words. A semantic system is an extension of Automatic Speech Recognition (ASR), wherein spoken words are not merely recognized for their sounds. The content and meaning of the spoken words are interpreted. For a full interactive system, the semantic Automatic Speech Recognition (ASR) can be coupled with a Text-To-Speech (TTS) system and a dialog manager to use a full dialog-based system for selecting the language and the person (102).

The scope of the invention can be extended to include TV programs where more than one newscaster read the news. The language selection remains the same but the user selects one target newscaster for each original newscaster. The overall structure of the system remains identical. The audio processor (11) keeps track of the original newscasters turns. The Audio-Visual TTS synthesizer (31) generates for each identified original newscaster the corresponding audio and video data for the target newscaster.

While the invention has been particularly shown and described with reference to a preferred embodiment, it will be understood that various changes in form and detail may be made therein without departing from the spirit, and scope of the invention.

What we claim is:

1. A method for personalizing a televison program, said method comprising the steps of:
receiving a command for translating from a first language into a second language a speech of a person in a television program and for replacing in said television program said first person by a second person;
separating said audio/video signal in:
an audio signal;
a video signal;
identifying in the audio signal
audio sequences corresponding to the speech of the first person;
other audio signals;
generating from the audio signal text corresponding to the speech of the first person;
generating time stamps corresponding to the identified audio sequences;
translating into the second language, the text corresponding to the speech of the first person;
generating from the translated text:
a synthesized audio signal corresponding to the speech translated into the second language;
a synthesized video signal showing the second person;
identifying from the video signal and the time stamps corresponding to the identified audio sequences:
video sequences showing the first person;
other video sequences;
generating a final video signal by replacing in the video signal, the video sequences showing the first person by the synthetized video signal showing the second person;
generating a final audio signal by replacing in the audio signal, the audio sequences corresponding to the speech recited by the first person in the first language by the synthetized audio signal corresponding to the speech translated into the second language;
generating a final audio/video signal by combining the final audio signal and the final video signal.

2. The method according to claim 1 wherein the step of generating a final video signal by replacing in the video signal, the video sequences showing the first person by the synthetized video signal showing the second person, comprises the further step of:
adding, modifying, cancelling one or a plurality of the video sequences not showing the first person.

3. The method according to claim 1 wherein the step of generating a final audio signal by replacing in the audio signal, the audio sequences corresponding to the speech recited by the first person in the first language by the synthetized audio signal corresponding to the speech translated into the second language; comprises the further step of:
adding, modifying, cancelling one or a plurality of the audio sequences not corresponding to the speech recited by the first person.

4. The method according to claim 1 wherein:
the television program is a news program;
said first person and said second person are newscasters.

5. The method according to claim 1 wherein the steps of:
identifying in the audio signal:
audio sequences corresponding to the speech of the first person;
other audio signals;
generating from the audio signal text corresponding to the speech of the first person;
generating time stamps corresponding to the identified audio sequences;
are performed by means of a broadcast news transcription system.

6. The method according to claim 1 wherein the step of translating into the second language, the text corresponding to the speech of the first person, is performed by means of an automatic machine translation system based on a language model.

7. The method according to claim 1 wherein the step of generating from the translated text:
a synthesized audio signal corresponding to the speech translated into the second language;
a synthesized video signal showing the second person;
is performed by means of an audio-visual text-to-speech synthetizer.

8. The method according to claim 1 comprising the preliminary step of:
receiving a command selecting a second language and a second person.

9. The method according to any one of the preceding claims comprising the further step of:
broacasting the final audio/video signal.

10. The method according to claim 1 comprising the further step of:
broadcasting the final audio/video signal to television viewers who have selected said second person and said second language.

11. A system comprising means adapted for carrying out the steps of the method according to claim 1.

12. The system according to claim 11 wherein said system receives the audio/video signal from a broadcast studio and send the final audio/video signal to a broadcast station.

13. The system according to claim 11 wherein said system receives the original audio/video signal from a television receiver and send the final audio/video signal to a television set.

14. A computer program comprising instructions for carrying out the method according to claim 1, when said computer program is executed on a computer system.
